(19) United States
(12) Patent Application Publication
(10) Pub. No.: US 2026/0336489 A1
(43) Pub. Date: Oct. 29, 2026

(54) TRIM ASSEMBLY AND A METHOD OF MANUFACTURING A TRIM ASSEMBLY

(71) Applicant: Lear Corporation, Southfield, MI (US)

(72) Inventors: Chandrashekar Simha, Shanghai (CN); Cuimei Zhang, Yangzhou (CN); Yao Yao, Shangahai (CN); Yaoju Song, Shanghai (CN); Yong Yang, Shanghai (CN); Shifeng Zhang, Shanghai (CN)

(21) Appl. No.: 19/661,731

(22) Filed: Apr. 29, 2026

(30) Foreign Application Priority Data
Apr. 29, 2025 (CN) CN202510565388

(51) Int. Cl. B60N 2/58; B29C 51/10; B29C 51/14; B29L 31/58; B60N 2/56; B60N 2/90

(52) U.S. Cl. CPC B60N 2/5891; B29C 51/10; B29C 51/14; B29L 2031/58; B60N 2/5657; B60N 2/976

(57) ABSTRACT

Disclosed is a trim assembly and a method of manufacturing trim assembly. The trim assembly comprises a first trim layer, a second trim layer, and a third trim layer attached to each other. The first trim layer comprises first surface and second surface. The second trim layer comprises third surface and fourth surface, third surface is adapted to be attached to second surface via layer bonding action(s) forming substrate layer. The third trim layer comprises fifth surface and sixth surface, the fifth surface is adapted to be attached to substrate layer via lamination action(s) to form a trim cover of vehicle seat assembly, trim cover is adapted to be contoured according to pre-defined dimension of external mold via thermo vacuum forming. In various non-limiting examples, the trim assembly may provide a snug fit, preventing folds, or wrinkles in trim cover and reduce manufacturing time of trim assembly.

### TECHNICAL FIELD

The present disclosure relates to a trim assembly. Moreover, the present disclosure relates to a method of manufacturing the trim assembly.

### BRIEF DESCRIPTION OF THE DRAWINGS

The following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a schematic illustration of a trim assembly, in accordance with an exemplary embodiment of the present disclosure;

FIG. 2 illustrates a schematic illustration of implementing thermo vacuum forming on the trim assembly, in accordance with an exemplary embodiment of the present disclosure;

FIG. 3 illustrates a schematic illustration of assembling the trim assembly on a seat assembly, in accordance with an exemplary embodiment of the present disclosure;

FIG. 4 illustrates a schematic illustration of views of the trim assembly comprising a plurality of attachment means, in accordance with another exemplary embodiment of the present disclosure; and

FIG. 5 illustrates a flowchart depicting the steps of a method of manufacturing the trim assembly, in accordance with an exemplary embodiment of the present disclosure.

### DETAILED DESCRIPTION OF EMBODIMENTS

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Vehicle seat assemblies are designed to provide comfort, durability, and aesthetic appeal while providing occupant safety and functionality. The vehicle seat assembly comprises various components such as a trim cover that is used to wrap the foam around a seat frame, thereby providing softness, breathability, and stretchability to the vehicle seat for the occupant comfort. Moreover, the trim cover improves the aesthetic appeal of the vehicle seat by incorporating color, texture, logos, prints, and so forth. In this regard, the trim cover is required to be attached and finished accurately in order to maintain a high-quality craftsmanship throughout a product lifecycle. Typically, the trim cover is made from soft materials such as textiles, leather, and the like. However, said trim materials cause wrinkles or crease on the trim cover during operations such as sewing and seat assembling process. Furthermore, apart from aesthetics or bad appearance, the formation of wrinkles or creases on the trim cover also leads to other problems such as, but not limited to, accumulation of dirt around the same or faster wear and tear of the trim cover. Moreover, the trim cover assembly process includes attaching the trim cover to the foam of the seat through various attachment mechanisms. There exists a need to overcome the aforementioned drawbacks associated with the trim assembly.

The present disclosure provides a trim assembly. The trim assembly comprises a first trim layer, a second trim layer, and a third trim layer that are attached to each other to form a trim cover. It will be appreciated the trim cover is formed using a flame lamination and a thermo vacuum forming process to provide a multi-layered contoured trim cover with the formed third trim layer. Moreover, the aforementioned process provides structural integrity, precise contouring, and material efficiency compared to a conventional trim cover. Additionally, the trim cover formed using a thermo vacuum forming is resistant to wrinkles, or creases. Furthermore, the trim cover comprises reduced seam lines and attachments with reduced sewing time. Furthermore, the trim cover comprises a simple design with a quick attachment process and therefore reducing a manufacturing time. Additionally, since the trim cover is thermo vacuum formed and can be used to cover around a seat component, the trim cover reduces the requirement of finessing which further reduces the manufacturing time. Furthermore, the trim assembly enables high-precision shaping, improved durability, and customized surface textures while maintaining lightweight and flexible design possibilities. Additionally, the process is cost-efficient, scalable for mass production, and adaptable to diverse industrial applications, including automotive interiors, aerospace panels, and ergonomic consumer products.

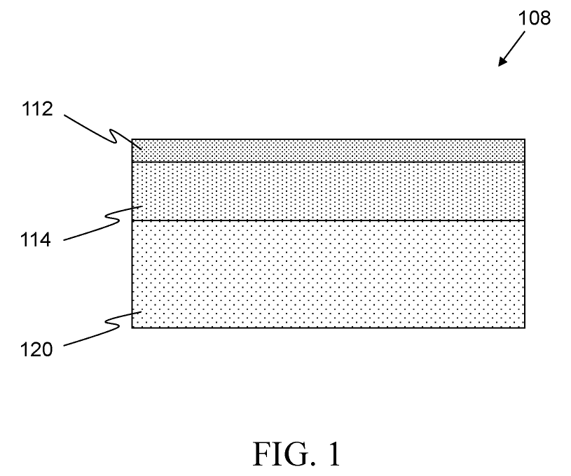

Referring to FIG. 1, illustrated is a schematic illustration of a trim assembly 108, in accordance with an exemplary embodiment of the present disclosure. The trim assembly 108 is adapted to provide a trim surface, or a visible surface to a variety of components. In an embodiment, the trim assembly 108 can be used in automotive interiors, aerospace, furniture manufacturing, consumer electronics, home appliances, medical devices, and so forth, to create quality, functional, and aesthetically pleasing components. In an embodiment, the trim assembly 108 is used to provide the trim surface to a seat component of a seat assembly 100. As shown, the trim assembly 108 comprises a first trim layer 112, a second trim layer 114, and a third trim layer 120. Throughout the present disclosure, the term "first trim layer" 112 as used herein refers to an outermost layer of the trim assembly 108 and adapted to provide an aesthetic appeal and functional protection to the seat assembly 100. In an example, the first trim layer 112 is adapted to protect the underlying layers and various components of a vehicle. In an embodiment, the first trim layer 112 is fabricated using a polyvinyl chloride material that provides several benefits, including high durability, affordability, low maintenance, easy to clean, and resistant to stains and spills. Said versatility of the polyvinyl chloride material allows for customization of the first trim layer 112 in various colors and patterns, while its water resistance makes the polyvinyl chloride material suitable for environments with frequent liquid exposure. Moreover, the polyvinyl chloride material is a dense material, thus resistant to allow deformation of the trim assembly 108 under pressure. In another embodiment, the first trim layer 112 comprises a thickness in a range of 0.3 millimeters (mm) to about 2 mm. In another embodiment, the first trim layer 112 is fabricated using a polyurethane foam material that provides a range of properties such as from flexibility to rigidity, making the polyurethane foam material versatile for different design requirements. In an embodiment, the first trim layer 112 is fabricated from the polyurethane foam material to provide softness, textures, colors, and other customization options for the first trim layer 112. In an embodiment, the first trim layer 112 can be fabricated using a combination of the polyvinyl chloride material, and the polyurethane foam material to form a hybrid material or a compact layer that can combine the desirable properties of the aforementioned materials. In another embodiment, the first trim layer 112 can be fabricated using a combination of the polyvinyl chloride material, and the polypropylene foam material to form a compact layer that can combine the desirable properties of the aforementioned materials. Moreover, the first trim layer 112 comprises a first surface and a second surface opposite to the first surface. The first surface is adapted to be exposed to the external environment, potentially incorporating features such as texture, color, or patterns. In an embodiment, the first surface may be treated with coatings or materials that enhance the durability, resistance to wear, and ease of cleaning of the first trim layer 112. The second surface is adapted to interface with the second trim layer 114. In an embodiment, the second surface includes adhesive properties to enable secure attachment to the second trim layer 114. In an embodiment, the first trim layer 112 can be adapted to be attached to the second trim layer 114 via at least one layer bonding action to form a substrate layer. In an embodiment, the layer bonding action is selected from at least one of: an adhesive bonding, a thermal fusion, a hot melt adhesive lamination, an infrared (IR) welding, or an ultrasonic welding. In such an embodiment, the layer bonding action used to attach the second surface of the first trim layer 112 to the third surface of the second trim layer 114 can be chosen from various methods. In an embodiment, the adhesive bonding action comprises using a glue substance to bond the first trim layer 112 and the second trim layer 114. In an embodiment, the thermal fusion comprises melting the materials together using heat to bond the first trim layer 112 and the second trim layer 114. In an embodiment, the hot melt adhesive lamination comprises using a hot adhesive to laminate the first trim layer 112 and the second trim layer 114. In an embodiment, the infrared (IR) welding employs infrared radiation to heat and bond the materials of the first trim layer 112 and the second trim layer 114. In an embodiment, the ultrasonic welding comprises using high-frequency ultrasonic acoustic vibrations to create a solid-state weld between the first trim layer 112 and the second trim layer 114. Each of the aforementioned actions provide different advantages such as strength, flexibility, and suitability for various materials and applications within the trim assembly. In an embodiment, the layer bonding action integrates the first trim layer 112 and the second trim layer 114 into a single, unified layer, called the substrate layer. The substrate layer serves as a foundational component within the trim assembly, providing structural integrity and support for subsequent layers. In an embodiment, the substrate layer can act as the intermediary layer to which the third trim layer 120 is attached via lamination actions. The layered construction enables that the trim cover, which forms the visible part of the seat assembly, is securely bonded and can be contoured according to the pre-defined dimensions of an external mold through the thermo vacuum forming.

Throughout the present disclosure, the term "second trim layer" 114 as used herein refers to an intermediate layer that is non-porous and is adapted to be attached to the first trim layer 112. The second trim layer 114 comprises a third surface and a fourth surface opposite to the third surface. In this regard, the second surface of the first trim layer 112 is adapted to be attached to the third surface of the second trim layer 114. The attachment of the second surface of the first trim layer 112 to the third surface of the second trim layer 114 requires precise alignment and secure bonding. In an embodiment, various equipment or actions, such as adhesive bonding or mechanical fastening, can be used to allow a reliable connection. In an embodiment, the second trim layer 114 is fabricated from a polypropylene foam material that is durable, lightweight, and user-friendly. Additionally, the polypropylene foam material comprises a closed-cell structure that provides water and moisture resistance to the second trim layer 114. In an embodiment, the polypropylene foam material provides cushioning properties and effective thermal insulation to the second trim layer 114. In an embodiment, the second trim layer 114 can be fabricated from the polyvinyl chloride material (as described above). In such an embodiment, the first trim layer 112 can be fabricated from any material other than polyvinyl chloride material according to an application of the trim assembly 108. In an embodiment, the second trim layer 114 can be fabricated from a closed cell foam material. In such an embodiment, the closed cell structure provides moisture resistance, thereby preventing water absorption and enhancing the durability of the second trim layer 114. Moreover, the closed cell structure provides thermal insulation, compressive strength and rigidity to the second trim layer 114, thereby providing longevity to the second trim layer 114. In another embodiment, the second trim layer 114 comprises a thickness in a range of 0.3 millimeters (mm) to about 2 mm. In an embodiment, the thickness of the first trim layer 112 can be less than the thickness of the second trim layer 114. In an embodiment, the density of the first trim layer 112 is greater than the density of the second trim layer 114. In an embodiment, the second trim layer 114 is adapted to be attached to the third trim layer 120 via the flame lamination action. In this regard, the second trim layer 114 is adapted to be passed past a flame to melt the fourth surface of the second trim layer 114 and attached to the third trim layer 120.

Throughout the present disclosure, the term "third trim layer" 120 as used herein refers to an innermost layer that is porous and is adapted to be attached to the second trim layer 114. The third trim layer 120 comprises a fifth surface and a sixth surface opposite to the fifth surface. The fourth surface of the second trim layer 114 is adapted to be attached to the fifth surface of the third trim layer 120. As shown, the first trim layer 112, the second trim layer 114, and the third trim layer 120 are adapted to be attached to each other to form a single unit or a single sheet of the trim assembly 108. In an embodiment, the third trim layer is adapted to be attached to the substrate layer via a flame lamination action. The flame lamination action is a commonly known process to bond one or more layers of material with each other. In this regard, the third trim layer 120 can be adapted to be passed past a flame to melt the substrate layer. Moreover, the third trim layer 120 is adapted to be contoured via a thermo vacuum forming process. In this regard, the third trim layer 120 is adapted to receive heat from an external source such that the material of the third trim layer 120 attached to the substrate layer becomes malleable or pliable. The pliability of the third trim layer 120 and the substrate layer provides contouring of the trim cover to a desired shape via the thermo vacuum forming process. Consequently, a vacuum is then applied, drawing the trim cover against an external mold and enabling the trim cover to conform to the external mold, resulting in a uniformly shaped trim cover. It will be appreciated that the trim cover formed using the thermo vacuum forming process is adapted to allow for the creation of complex shapes and detailed surface textures, providing a high-quality finish for the trim cover. The resulting trim cover, formed from the sixth surface, exhibits enhanced durability and aesthetic appeal, making it ideal for use in various applications where both functionality and appearance are important. In one embodiment, the trim cover is applied to vehicle seat assemblies, to provide a protective and decorative layer that enhances the overall appearance and comfort of the seat. In one embodiment, the trim cover can be employed in automotive interiors to cover door panels, dashboards, and other surfaces, providing a cohesive and stylish appearance. In one embodiment, the trim cover can be employed in various furniture pieces to improve their aesthetic appeal and comfort. In one embodiment, the trim cover can be employed in electronic devices to provide protection and a customized look. In an embodiment, the third trim layer 120 is fabricated from a polyethylene (PE) foam material. The PE foam material is lightweight, semi-rigid, and highly durable, making it ideal for seat trim applications that require long-term resilience and impact resistance. Additionally, the smooth surface of the PE foam material enables precise molding, thereby enabling a sharp contour definition of the trim assembly 108. In an embodiment, the third trim layer 120 is fabricated from a polyurethane (PU) foam material. The PU foam material provides increased cushioning and softness, making it ideal for comfort-focused trim assembly applications. The PU foam material comprises high elasticity and shape retention to enable the trim assembly to maintain its contoured shape over time, thus reducing wrinkles and deformation. In an embodiment, the PU foam material can increase acoustic damping to reduce seat-generated vibrations and noise within a vehicle cabin. In an embodiment, the third trim layer 120 is fabricated from an open cell foam material. The open-cell foam is breathable and allows for airflow and moisture regulation, thus making the trim assembly 108 beneficial for temperature-controlled and ventilated trim assemblies. While specific embodiments have been described, the disclosed trim assembly 108 may include one or more trim layers arranged in any sequence to form the trim cover.

In an embodiment, the first trim layer 112 is fabricated from the polyvinyl chloride material and the second trim layer 114 is fabricated from the polypropylene foam material. In such an embodiment, the first trim layer 112 comprises a thickness of about 0.2 mm to about 1 mm. In such an embodiment, the second trim layer 114 comprises a thickness of about 0.2 mm to about 1.8 mm. In such an embodiment, the substrate layer comprises a thickness of about 0.2 mm to about 2.5 mm. In an embodiment, the third trim layer 120 comprises a thickness of about 3 mm to about 9 mm. In an embodiment, the third trim layer 120 is fabricated from a polyurethane (PU) foam material. The PU foam material provides increased cushioning and softness, making third trim layer 120 used for comfort-focused trim assembly applications. The PU foam material comprises high elasticity and shape retention to enable the third trim layer 120 to maintain a contoured shape over a period of time, thus reducing wrinkles and deformation thereof. Moreover, the third trim layer 120 is adapted to receive an external force via the mold (as described above in FIG. 1). In an embodiment, the external force can be applied through a pressing, a vacuum forming, or heat molding process. In an exemplary embodiment, the third trim layer 120 is adapted to receive the external force that conforms the third trim layer 120 according to the dimensions or a shape and a size of the external mold. In an exemplary embodiment, the attached substrate layer is adapted to follow the contour due to the secure attachment to the third trim layer 120, thus forming the trim cover. In an exemplary embodiment, the trim cover is a contoured trim cover for various applications such as a vehicle seat trim cover.

In an embodiment, the third trim layer 120 is adapted to be laminated on the substrate layer via the flame lamination action (as described above). The flame lamination produces a bond between the third trim layer 120 and an adjacent layer such as the substrate layer. One or more of the adhesive layers may be optionally replaced by the flame lamination. In an embodiment, two or more layers may be adhered by the flame lamination prior to or after adhering one or more additional layers with adhesive if desired. It will be appreciated that the selection of adhesive type (such as 1K or 2K urethane adhesives) and/or the flame lamination is based in part on the selected upper layer and the desired processing methods. In an exemplary embodiment, the substrate layer is adapted to be coated with a lacquer finish. Typically, the lacquer finish can be applied on surfaces that are frequently touched or exposed to wear and tear. In an exemplary embodiment, the lacquer finish can be applied on a surface of the substrate layer or the first surface of the first trim layer 112 to provide a smooth, hard, and durable coating. In an exemplary embodiment, the lacquer finish comprises quick-drying properties and ability to create a high-gloss and aesthetically pleasing appearance. In an embodiment, the lacquer finish may form a protective layer that provides longevity to the substrate layer.

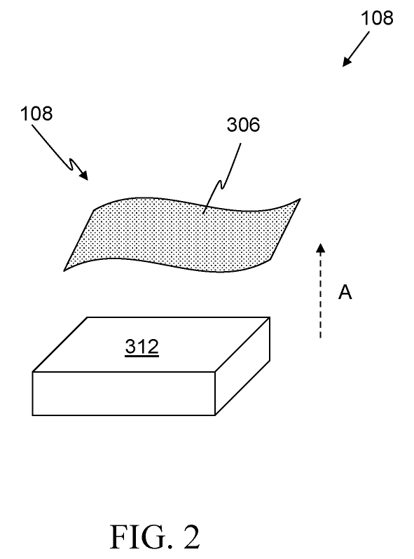

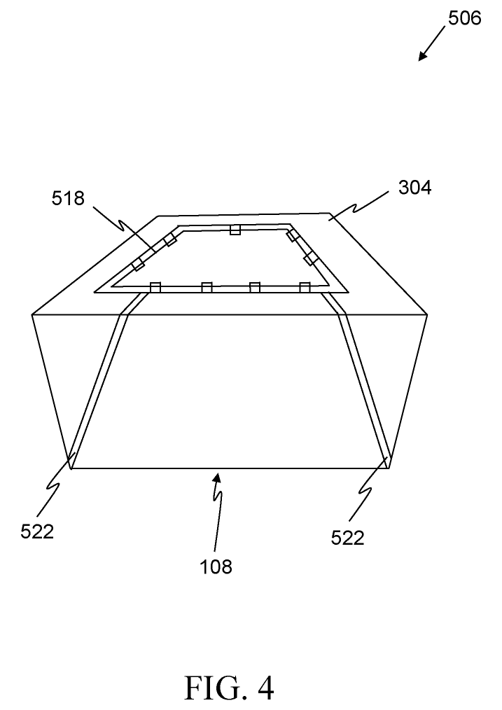

Referring to FIG. 2, illustrated is a schematic illustration of implementing thermo vacuum forming on the trim assembly 108 (as described above in FIG. 1), in accordance with an exemplary embodiment of the present disclosure. The trim assembly comprises the first trim layer 112 (as described above in FIG. 1), the second trim layer 114 (as described above in FIG. 1) and the third trim layer 120 (as described above in FIG. 1) attached to each other via various actions such as the flame lamination. In an embodiment, the trim cover is adapted to be shaped under differential pressure generated by a vacuum source and softened through localized heating for contouring of the first trim layer, the second trim layer and the third trim layer. In such an embodiment, the trim cover is further adapted to be pre-stretched using a tensioning mechanism and stabilized through controlled cooling. Moreover, the first trim layer 112, the second trim layer 114 and the third trim layer 120 are adapted to be attached to each other to form the trim cover 306 (as described above). As shown, the trim assembly that comprises the trim cover 306 is associated with a thermo vacuum forming tool. In this regard, the thermo vacuum forming tool comprises various components such as a platform or platen for supporting an external mold 312, an adjustable clamp for securing the trim cover 306, a heating element for rendering the trim cover 306 pliable, and a vacuum system for creating a pressure differential to conform the trim cover 306 to the external mold 312. In an embodiment, the external mold 312 comprises a predefined shape and size and is positioned against the third trim layer of the trim cover 306. In an embodiment, the external mold 312 can be either male or female and defines the final shape of the trim cover 306. As shown, the external mold 312 is pressed from below (as depicted by an arrow A in FIG. 2), thermoformed (heated mold applied with pressure), or vacuum-formed to apply the external force effectively on the third trim layer and subsequently on the attached first trim layer and the second trim layer. Moreover, during the thermo vacuum forming, the applied vacuum enables that the trim cover 306 conforms tightly to the external mold 312 until the trim cover 306 fully sets, thereby preventing deformations of the trim cover 306 post-processing. It will be appreciated that since the third trim layer is securely bonded to the underlying layers, the applied force is distributed across all the attached layers. The distribution of the applied force enables that the entire trim cover 306 adopts the contour of the external mold 312, thereby preventing wrinkles, inconsistencies, or misalignment in the final shape of the trim cover 306. In some embodiments, a pneumatic or a hydraulic pressure can be used to exert uniform force across the sixth surface of the third trim layer. As shown, the third trim layer, made of a formable material (such as polyurethane foam, polyethylene foam, or thermoplastic elastomers), undergoes controlled deformation under the applied external force. It will be appreciated that the elastic or the thermoplastic properties of the first trim layer, the second trim layer, and the third trim layer enables the trim cover 306 to take the shape of the external mold 312, thereby providing a smooth, contoured surface that aligns with a seat component of a seat assembly (as described below in FIG. 4). In an embodiment, the thermo vacuum forming tool may include a cooling system integrated into the mold for rapid cooling and setting of the formed trim cover 306 when the thermo vacuum forming process involves heat molding. In such an embodiment, the third trim layer is allowed to cool down while maintaining the contoured shape, thereby allowing a long-term shape retention. In an embodiment, the thermo vacuum forming tool can include a control unit that allows for management of temperature, vacuum pressure, and cycle time, thereby providing a consistent and accurate formation of the trim cover 306. It will be appreciated that unlike sandwich molding, which presses both sides and can compress cushioning layers excessively, the trim assembly is adapted to allow the molding of the third trim layer while maintaining the integrity and functionality of the underlying layers. This leads to optimized seat comfort, as the cushioning properties remain intact while achieving a contoured outer shape. Additionally, the aforementioned molding action eliminates the need for additional cutting, stitching, or reinforcement of the trim cover 306 to achieve a contoured finish, reducing material waste and production time. Furthermore, the aforementioned molding action is compatible with automated manufacturing actions, thus improving production consistency and repeatability. In an exemplary embodiment, the trim cover 306 is an automotive seat trim cover formed using the thermo vacuum forming process. In such an exemplary embodiment, the thermo vacuum forming process enables that the third trim layer fabricated from the polyurethane foam layer is molded against a seat-shaped mold, thereby enabling accurate alignment of the trim cover 306 with the seat component’s contours. Said single-sided molding action results in the wrinkle free and aesthetic fit and finish while retaining the comfort-enhancing properties of the trim cover 306.

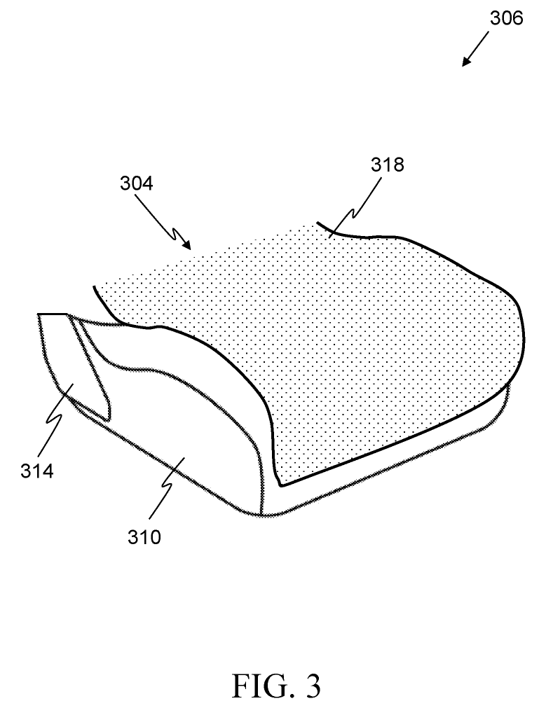

Referring to FIG. 3, illustrated is a schematic illustration of assembling a trim cover 304 covering on a seat assembly 306, in accordance with an exemplary embodiment of the present disclosure. While the vehicle seat assembly 306 is shown, it should be understood that the principles of the present disclosure are applicable to other types of seat assemblies, such as an office chair, or any individual chair and other seat assemblies. It should also be understood that the principles of the present disclosure are applicable to other vehicle interior trim components such as seat bottoms, back support pads, armrests, and head restraints where aesthetic features may be desired. Still further, it should also be understood that the principles of this disclosure are applicable to all types of vehicle seat assemblies as well as non-vehicle seat assemblies, and discussion of a vehicle seat is not intended to be limiting. The seat assembly 306 can be adapted for use in the vehicle, such as motor vehicle like a car or truck, or for use in non-vehicular applications. The seat assembly 306 includes a seat bottom 310 and a seat back disposed on the seat bottom 310, a headrest attached to the seat back, and the trim assembly 108 (as described above in FIG. 1). The seat bottom 310 is mountable to a surface such as a vehicle floor. The seat bottom 310 and the seat back each include one or more seat cushions supported on a seat frame 314 for forming the seat assembly 306. The seat cushions are disposed under the trim assembly. The trim assembly comprises a plurality of components such as the trim cover 304, the plurality of attachment mechanisms, and the plurality of decorative seams. In an embodiment, the trim cover 304 is adapted to cover a seat component such as the seat bottom 310 and the seat back of the seat assembly 306. The trim cover 304 is adapted to provide an exterior seating surface, also known as the A-surface, which can be an occupant support surface for the seat assembly 306. It should be understood that the seat cushion for the seat back can differ from the cushion of the seat bottom 310. Likewise, it should be understood that the trim cover 304 for the seat back can differ from the trim cover for the seat bottom 310. The trim cover 304 can readily be useable in a heat/cool seat assembly 306 but may be equally useable with other types of seat assemblies. The trim cover 304 comprises the first trim layer, the second trim layer, and the third trim layer that are attached to each other. It will be appreciated that the trim cover 304 is adapted to enclose and conform to the seat component, such as the seat cushion, the seat backrest, the headrest, or the armrest. In an embodiment, the first trim layer, the second trim layer and the third trim layer are adapted to be contoured at pre-determined conditions to form the trim cover, and wherein the pre-determined conditions comprise a temperature, a period of time, a pressure, a humidity level, a vacuum level, or a deformation force. In an embodiment, applying heat softens the first trim layer, the second trim layer and the third trim layer allowing the first trim layer, the second trim layer and the third trim layer to conform precisely to the shape of the seat component. In an embodiment, the heat further enhances adhesion between the first trim layer, the second trim layer and the third trim layer. The controlled heating process improves the trim cover’s 304 durability, shape retention, and surface finish. In an embodiment, the heat can be applied through thermal presses, infrared heaters, convection ovens, or heated molds, depending on the material composition of the first trim layer, the second trim layer and the third trim layer. The temperature and duration are pre-determined based on the specific properties of the trim materials to achieve optimal flexibility without degrading structural integrity. During the heating, the heat activates the adhesive or bonding agent between the first trim layer, the second trim layer and the third trim layer. The applied heat also allows the third trim layer to be effectively contoured by the external mold. Once the desired shape is achieved, the first trim layer, the second trim layer and the third trim layer are allowed to cool, thereby locking the contoured form in place. The trim cover 304 provides both a protective and aesthetic function while providing a comfortable seating experience. Additionally, the trim cover 304 may be adapted to integrate functional features such as ventilation, heating, or sensory feedback systems. In this regard, the trim cover 304 can be shaped and contoured to fit the seat component using a combination of pre-molded shaping, elastic properties, adhesives, stitching, or mechanical fasteners such as hook-and-loop strips or clips. In an embodiment, the trim cover 304 can be attached permanently or designed for easy removal and replacement. In an embodiment, the layered structure of the trim cover 304 can be adapted to maintain a snug fit over the seat component without wrinkles or sagging, preserving an ergonomic and premium finish. Furthermore, the layered structure of the trim cover 304 enables ease of manufacturing and assembly, thereby reducing production variability and providing consistency across different seat assemblies.

In an embodiment, the trim cover 304 further comprises a plurality of perforations 318 adapted to allow an air movement through the trim cover 304. In this regard, the plurality of perforation 318 are small openings that allow air to move through the first trim layer, the second trim layer, and the third trim layer of the trim cover 304. In an embodiment, the plurality of perforations 318 can be uniformly distributed or selectively positioned based on functional and aesthetic requirements of the trim cover 304. In an embodiment, the plurality of perforations 318 can increase breathability, comfort, and temperature regulation of the trim cover 304. This is beneficial in applications such as ventilated or heated seats, where airflow through the trim cover 304 is necessary for efficient thermal management. Additionally, the plurality of perforations 318 contribute to moisture control, reducing heat buildup and perspiration for improved occupant comfort. In an embodiment, the plurality of perforations 318 can be created using laser cutting, mechanical punching, or precision molding during the manufacturing process. In an embodiment, a size, density, and pattern of the plurality of perforations 318 can be customized based on airflow requirements and aesthetic preferences. In an embodiment, the plurality of perforations 318 can also be designed in combination with a porous or breathable material in the inner trim layers to optimize airflow. In an exemplary embodiment, the seat assembly 306 is a ventilated seat assembly that comprises the trim cover 304 with the plurality of perforations 318. In such an exemplary embodiment, the plurality of perforations 318 can allow the air to be drawn in or pushed out by an integrated fan system, thereby promoting temperature regulation. In an exemplary embodiment, the seat assembly 306 may include a heated seat configuration to facilitate even heat distribution by reducing thermal insulation from the trim cover 304. In such an exemplary embodiment, a topper or an additional pad layer of cushioning can be integrated into the seat assembly 306 to enhance comfort and support. In such an exemplary embodiment, the additional pad layer can be positioned between the seat cushion and a heating element to provide extra softness and reduce pressure points. In another exemplary embodiment, the seat assembly 306 can comprise the trim cover 304 that is further associated with a separate layer (air-permeable spacer layer). In this regard, the air-permeable spacer layer can be placed between the seat cushion and the topper layer to allow the air movement in the seat assembly 306. In such an exemplary embodiment, the seat assembly 306 can further include a plurality of massage components arranged between the heating element and the spacer layer.

Referring to FIG. 4 illustrated is a schematic illustration of views of the trim assembly 108 (as described above in FIG. 1) comprising a plurality of attachment means, in accordance with another exemplary embodiment of the present disclosure. There is shown a bottom perspective view of the seat component 506 of the seat assembly (as described above in FIG. 4). Herein, the seat component can be the seat bottom, or the seat back attached to the seat frame (as described above in FIG. 4). The seat component 506 is associated with the trim cover 304 (as described above in FIG. 3). In other words, the trim cover 304 is adapted to cover the seat component 506. As shown, the trim assembly further comprises a plurality of decorative seams adapted to attach the trim cover 304 to the seat component 506. In this regard, the plurality of seams is adapted to provide structural reinforcement to the trim cover 304, thereby enabling long-term durability and resistance to wear. In an embodiment, the plurality of decorative seams can create distinct styling patterns, adding a premium look to the seat assembly, which is required in automotive, aviation, and luxury seating applications. Additionally, the plurality of decorative seams can be designed to integrate with functional elements such as perforations for ventilation or reinforced zones for added comfort and support. In an embodiment, the plurality of decorative seams can be formed using various stitching actions, including double-stitching, topstitching, French seams, or contrast stitching, depending on the design requirements. In an embodiment, the plurality of decorative seams can be created using high-strength synthetic or natural threads to provide resistance to tension, temperature variations, and repeated use to the trim cover 304. In an embodiment, the plurality of decorative seams can include embedded reinforcements such as thermoplastic welds or adhesive bonding layers to enhance durability. In an embodiment, the positioning of the plurality of decorative seams can be determined based on the seat component’s 506 contours, ergonomic considerations, and fastening points. In such an embodiment, the accurate positioning of the plurality of decorative seams secures the trim cover in place over time. Furthermore, the plurality of decorative seams can contribute to the customization and brand differentiation of seat designs, thereby allowing manufacturers to create unique patterns while maintaining functional integrity of the seat trim assembly.

In an embodiment, the trim assembly further comprises a plurality of attachment means adapted to attach the trim cover 304 to the seat assembly. The plurality of attachment means provide a reliable and efficient method for installing, maintaining, and replacing the trim cover 304 while providing a secure and wrinkle-free fit. In an embodiment, the trim cover 304 is adapted to be attached to the seat component 506 via the plurality of attachment means selected from at least one of: a snap-fit mechanism, a welt, a trench, a retainer, a strap, a wire, or a zipper. In an embodiment, the snap-fit mechanism comprises interlocking components that securely hold the trim cover 304 in place while allowing easy disassembly when needed. As shown, the trim cover 304 includes the welt 518 that provides a reinforced edge or piping that fits into a groove or channel to provide a seamless and secure fit. In an embodiment, the trench can be used that provide a recessed area within the seat frame that accommodates the trim cover’s 304 edge, ensuring a smooth transition between different seat sections. In an embodiment, the trim cover 304 can include the retainer as a fastening component to hold the trim cover 304 under tension, thus preventing the trim cover 304 from shifting. In an embodiment, the trim cover 304 can include the strap which is a flexible band or an elastic component that wrap around structural seat elements, securing the trim cover 304 in place. In another embodiment, the trim cover 304 can include the wire such as a tensioned wire running through a hemmed section of the trim cover 304, thereby allowing the trim cover 304 to be pulled tight and fastened securely to the seat frame. In another embodiment, the trim cover 304 can include the zipper 522 that enables easy attachment and removal of the trim cover 304 while maintaining a secure fit. It will be appreciated that the plurality of attachment means allows that the trim cover 304 is firmly secured to the seat assembly, thus preventing looseness, the wrinkles, or the misalignment over time. The different fastening options provide flexibility in design and manufacturing, allowing for both permanent and removable installations based on the user needs. Additionally, the trim assembly is adapted to be associated with the plurality of attachment means to improve serviceability and cost efficiency, as the trim covers 304 can be replaced or adjusted without requiring complex disassembly.

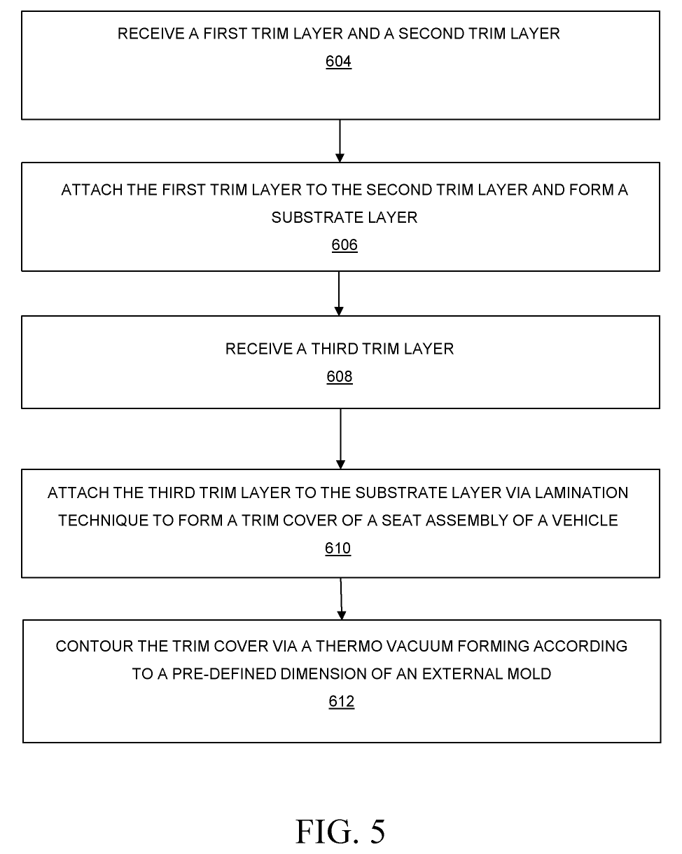

Referring to FIG. 5 illustrated is a flowchart depicting the steps of a method of manufacturing the trim assembly, in accordance with an exemplary embodiment of the present disclosure. At step 604, a first trim layer and a second trim layer are received. The first trim layer comprises a first surface and a second surface, and the second trim layer comprises a third surface and a fourth surface. The step of receiving the first trim layer and the second trim layer comprises delivering the first trim layer and the second trim layer at a manufacturing station. In an embodiment, at the first manufacturing station, the first trim layer and the second trim layer can be inspected for quality and prepared for subsequent processing. The technical effect of this step is to confirm that the first trim layer and the second trim layer are in optimal condition for attachment, thereby facilitating a seamless integration in the following steps. At step 606, the first trim layer is attached to the second trim layer such that the third surface of the second trim layer is adapted to be attached to the second surface of the first trim layer. The attachment process may involve adhesive bonding, stitching, or other suitable methods to enable a secure and durable connection. The technical effect of this step is to create a substrate layer or a composite structure that combines the properties of both the first trim layer and the second trim layer, thereby improving the overall strength and functionality of the trim assembly. At step 608, a third trim layer is received. The third trim layer comprises a fifth surface and a sixth surface. Similar to step 604, the step of receiving the third trim layer involves delivering the third trim layer to the manufacturing station and preparing the third trim layer for attachment. The technical effect of this step is to introduce an additional layer that is adapted to provide a contour to the trim cover. At step 610, the first trim layer and the second trim layer that forms a substrate layer are flame laminated with the third trim layer. In this regard, the fifth surface of the third trim layer is adapted to be attached to the fourth surface of the second trim layer via a lamination technique. At this step, the flame laminating involves using a controlled flame to activate the adhesive properties of the first trim layer and the second trim layer, thus bonding the first trim layer and the second trim layer together securely. The fifth surface of the third trim layer is attached to the substrate layer to form a trim cover of a seat assembly of a vehicle. The technical effect of this step is to ensure a strong and uniform bond between the first trim layer and the second trim layer. At step 612, thermo vacuum forming is applied to the first trim layer, the second trim layer, and the third trim layer of the trim cover. At this step, the thermo vacuum forming involves heating the trim cover and using a vacuum pressure to contour the trim cover according to a pre-defined dimension of an external mold. In an embodiment, the step of applying the thermo vacuum forming on the trim cover comprises heating the trim cover at a pre-determined temperature at a pre-determined period of time. In such an embodiment, the step of applying the thermo vacuum forming further comprises applying vacuum pressure on the trim cover by pulling the external mold against the trim cover. In such an embodiment, the step of applying the thermo vacuum forming further comprises contouring the trim cover according to the pre-defined dimension shape of the external mold to form the contoured trim cover. The technical effect of the aforementioned steps is to provide a desired shape and finish to the trim cover, thereby enabling the trim cover to fit precisely to a seat component. Additionally, the method is streamlined with the aforementioned efficient attachment process, thus reducing a cycle time for manufacturing the trim assembly.

In a first aspect, the present disclosure provides a trim assembly. The trim assembly comprises a first trim layer, the first trim layer comprises a first surface and a second surface; a second trim layer, the second trim layer comprises a third surface and a fourth surface, wherein the third surface is adapted to be attached to the second surface of the first trim layer via at least one layer bonding action forming a substrate layer; and a third trim layer, the third trim layer comprises a fifth surface and a sixth surface, wherein the fifth surface is adapted to be attached to the substrate layer via at least one lamination action forming a trim cover of a seat assembly of a vehicle, and wherein the trim cover is adapted to be contoured according to a pre-defined dimension of an external mold via a thermo vacuum forming.

In an embodiment, the first trim layer is fabricated from one of: a polyvinyl chloride material, or a polyurethane foam material.

In an embodiment, the second trim layer is fabricated from one of: a polypropylene foam material, a polyvinyl chloride material, or a closed cell foam material.

In an embodiment, the third trim layer is fabricated from one of: a polyethylene foam material, a polyurethane foam material, or an open cell foam material.

In an embodiment, the first trim layer and the second trim layer are adapted to be attached using at least one layer bonding action selected from at least one of: an adhesive bonding, a thermal fusion, a hot melt adhesive lamination, an infrared (IR) welding, or an ultrasonic welding.

In an embodiment, the third trim layer is adapted to be attached to the substrate layer via a flame lamination action.

In an embodiment, the trim cover is adapted to be: shaped under differential pressure generated by a vacuum source; softened through localized heating for contouring of the first trim layer, the second trim layer and the third trim layer; pre-stretched using a tensioning mechanism; and stabilized through controlled cooling.

In an embodiment, the first trim layer, the second trim layer and the third trim layer are adapted to be contoured at pre-determined conditions to form the trim cover, and wherein the pre-determined conditions comprises a temperature, a period of time, a pressure, a humidity level, a vacuum level, and a deformation force.

In an embodiment, the trim cover further comprises a plurality of perforations adapted to allow an air movement through the trim cover.

In an embodiment, the trim assembly further comprises a plurality of attachment means adapted to attach the trim cover to the seat assembly, wherein the plurality of attachment means comprises one of: a snap-fit mechanism, a welt, a trench, a retainer, a strap, a wire, or a zipper.

In a second aspect, the present disclosure provides a method that comprises: receiving a first trim layer and a second trim layer, wherein the first trim layer comprises a first surface and a second surface, and wherein the second trim layer comprises a third surface and a fourth surface; attaching via at least one layer bonding action, the second surface of the first trim layer to the third surface of the second trim layer and forming a substrate layer; receiving a third trim layer, wherein the third trim layer comprises a fifth surface and a sixth surface; attaching via at least one lamination action, the fifth surface of the third trim layer to the substrate layer to form a trim cover of a seat assembly of a vehicle; and contouring the trim cover via a thermo vacuum forming according to a pre-defined dimension of an external mold.

In an embodiment, the step of applying the thermo vacuum forming on the trim cover comprises: heating the trim cover at a pre-determined temperature for a pre-determined period of time; applying vacuum pressure on the trim cover by pulling the external mold against the trim cover; and contouring the trim cover according to the pre-defined dimension of the mold to form the contoured trim cover.

In a third aspect, the present disclosure provides a seat assembly for a vehicle. The seat assembly comprises: a seat frame adapted to support a seat bottom and a seat back; a seat cushion disposed on the seat frame; a spacer layer operatively coupled to the seat cushion, the spacer layer is adapted to allow air movement through the seat cushion; and a trim cover disposed over the seat cushion. The trim cover comprises: a first trim layer, the first trim layer comprises a first surface and a second surface; a second trim layer, the second trim layer comprises a third surface and a fourth surface, wherein the third surface is adapted to be attached to the second surface of the first trim layer via at least one layer bonding action to form a substrate layer, and a third trim layer, the third trim layer comprises a fifth surface and a sixth surface, wherein the fifth surface is adapted to be attached to the substrate layer via at least one lamination action, wherein the trim cover is adapted to be contoured according to a pre-defined dimension of an external mold via a thermo vacuum forming such that the trim cover conforms to a shape of the seat cushion.

In an embodiment, the trim cover further comprises a plurality of perforations to allow the air movement generated via a fan through the trim cover.

In an embodiment, the seat assembly further comprises: a heating element disposed between the seat cushion and the trim cover; and a topper layer positioned between the seat cushion and the heating element, the topper layer is adapted to provide softness and control pressure points of the seat cushion.

In an embodiment, the seat assembly further comprises a plurality of massage components positioned between the heating element and the spacer layer, the plurality of massage components is adapted to generate massage effect in the seat cushion.

FIGS. 1, 2, 3, 4, and 5 are merely examples, which should not unduly limit the scope of the claims herein. A person skilled in the art will recognize many variations, alternatives, and modifications of embodiments of the present disclosure.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, the features of various implementing embodiments may be combined to form further embodiments according to the disclosure.

What is claimed is:

1. A trim assembly, comprising:
a first trim layer, the first trim layer comprises a first surface and a second surface;
a second trim layer, the second trim layer comprises a third surface and a fourth surface, wherein the third surface is adapted to be attached to the second surface of the first trim layer via at least one layer bonding action forming a substrate layer; and
a third trim layer, the third trim layer comprises a fifth surface and a sixth surface, wherein the fifth surface is adapted to be attached to the substrate layer via at least one lamination action forming a trim cover of a seat assembly of a vehicle, and wherein the trim cover is adapted to be contoured according to a pre-defined dimension of an external mold via a thermo vacuum forming.

2. The trim assembly of claim 1, wherein the first trim layer is fabricated from one of: a polyvinyl chloride material, or a polyurethane foam material.

3. The trim assembly of claim 1, wherein the second trim layer is fabricated from one of: a polypropylene foam material, a polyvinyl chloride material, or a closed cell foam material.

4. The trim assembly of claim 1, wherein the third trim layer is fabricated from one of: a polyethylene foam material, a polyurethane foam material, or an open cell foam material.

5. The trim assembly of claim 1, wherein the first trim layer and the second trim layer are adapted to be attached using at least one layer bonding action selected from at least one of: an adhesive bonding, a thermal fusion, a hot melt adhesive lamination, an infrared (IR) welding, or an ultrasonic welding.

6. The trim assembly of any of claim 1, wherein the third trim layer is adapted to be attached to the substrate layer via a flame lamination action.

7. The trim assembly of claim 1, wherein the trim cover is adapted to be: shaped under differential pressure generated by a vacuum source; softened through localized heating for contouring of the first trim layer, the second trim layer and the third trim layer; pre-stretched using a tensioning mechanism; and stabilized through controlled cooling.

8. The trim assembly of claim 1, wherein the first trim layer, the second trim layer and the third trim layer are adapted to be contoured at pre-determined conditions to form the trim cover, and wherein the pre-determined conditions comprise a temperature, a period of time, a pressure, a humidity level, a vacuum level, and a deformation force.

9. The trim assembly of claim 1, wherein the trim cover further comprises a plurality of perforations adapted to allow an air movement through the trim cover.

10. The trim assembly of claim 1, further comprises a plurality of attachment means adapted to attach the trim cover to the seat assembly, wherein the plurality of attachment means comprises one of: a snap-fit mechanism, a welt, a trench, a retainer, a strap, a wire, or a zipper.

11. A method, comprising:
receiving a first trim layer and a second trim layer, wherein the first trim layer comprises a first surface and a second surface, and wherein the second trim layer comprises a third surface and a fourth surface;
attaching via at least one layer bonding action, the second surface of the first trim layer to the third surface of the second trim layer and forming a substrate layer;
receiving a third trim layer, wherein the third trim layer comprises a fifth surface and a sixth surface;
attaching via at least one lamination action, the fifth surface of the third trim layer to the substrate layer to form a trim cover of a seat assembly of a vehicle; and
contouring the trim cover via a thermo vacuum forming according to a pre-defined dimension of an external mold.

12. The method of claim 11, wherein the step of applying the thermo vacuum forming on the trim cover comprises:
heating the trim cover at a pre-determined temperature for a pre-determined period of time;
applying vacuum pressure on the trim cover by pulling the external mold against the trim cover; and
contouring the trim cover according to the pre-defined dimension of the external mold to form the contoured trim cover.

13. A seat assembly for a vehicle, comprising:
a seat frame adapted to support a seat bottom and a seat back;
a seat cushion disposed on the seat frame;
a spacer layer operatively coupled to the seat cushion, the spacer layer is adapted to allow air movement through the seat cushion; and
a trim cover disposed over the seat cushion, the trim cover comprises:
a first trim layer, the first trim layer comprises a first surface and a second surface,
a second trim layer, the second trim layer comprises a third surface and a fourth surface, wherein the third surface is adapted to be attached to the second surface of the first trim layer via at least one layer bonding action forming a substrate layer, and
a third trim layer, the third trim layer comprises a fifth surface and a sixth surface, wherein the fifth surface is adapted to be attached to the substrate layer via at least one lamination action, wherein the trim cover is adapted to be contoured according to a pre-defined dimension of an external mold via a thermo vacuum forming such that the trim cover conforms to a shape of the seat cushion.

14. The seat assembly of claim 13, wherein the trim cover further comprises a plurality of perforations to allow the air movement generated via a fan through the trim cover.

15. The seat assembly of claim 13, wherein the seat assembly further comprises:
a heating element disposed between the seat cushion and the trim cover; and
a topper layer positioned between the seat cushion and the heating element, the topper layer is adapted to provide softness and control pressure points of the seat cushion.

16. The seat assembly of claim 15, wherein the seat assembly further comprises a plurality of massage components positioned between the heating element and the spacer layer, the plurality of massage components is adapted to generate massage effect in the seat cushion.
